(19) United States
(12) Patent Application Publication
(10) Pub. No.: US 2009/0313160 A1
(43) Pub. Date: Dec. 17, 2009

(54) Hardware accelerated exchange order routing appliance

(75) Inventors: Gene Kolten, Denville, NJ (US); Vladislav Rysin, Upper Grandview, NY (US)

Correspondence Address: KING & SPALDING, 1180 PEACHTREE STREET , NE, ATLANTA, GA, 30309-3521, US

(73) Assignee: Credit Suisse Securities (USA) LLC, New York, NY (US)

(21) Appl. No.: 12/157,535

(22) Filed: Jun. 11, 2008

(51) Int. Cl. G06Q 40/00

(52) U.S. Cl. 705/37

(57) ABSTRACT

A system for processing a trading order message comprises a hardware device logically linked to a general purpose processor. The hardware device comprises multiple exchange line handlers each of which is associated with a market exchange, multiple parsing modules each of which is associated with one of the exchange line handlers, and a message router that receives the message from the general purpose processor, determines a particular market exchange to which the message is directed, and communicates the message to a particular one of the parsing modules that is associated with a particular one of the exchange line handlers that is associated with the particular market exchange. The particular one of the parsing modules transforms the message into a protocol specified by the particular market exchange and communicates the transformed message to the particular one of the exchange line handlers for communication to the particular market exchange.

### TECHNICAL FIELD

The present invention relates to processing securities trading orders. More particularly, the present invention relates to a combination of software and hardware accelerated processing of such orders.

### BACKGROUND

All electronic trading venues, such as the New York Stock Exchange, mandate and regulate the order submission process for buying and selling securities. Each trading venue has its own set of rules, protocols, and processes that a member institution, such as a broker or a dealer, must follow to execute buy/sell orders via that trading venue. Buy/sell orders must be transformed to meet the specific rules, protocols, and processes of a particular trading venue prior to submitting those orders to the trading venue for execution. Conventionally, securities brokers and dealers have developed software processing models operating on one or more software servers for receiving or generating buy/sell orders, processing the orders for submission to a particular trading venue, communicating the orders to that trading venue, and tracking the status of the orders.

Since the price of securities fluctuates over time, it is important to process and submit buy/sell orders to the appropriate trading venue in a timely manner with high speed (low and predictable latency) and high throughput (number of orders per second). Conventional software approaches to processing and submitting buy/sell orders have limited speed and throughput, thereby making such systems less desirable. Most conventional systems were developed many years ago and operate on software platforms that include inherent latency and throughput constraints.

In 2005, the Securities and Exchange Commission approved Regulation NMS (“Reg NMS”), which established certain common rules for the trading venues. The implementation of Reg NMS has caused the number of buy/sell orders to increase dramatically, further straining the processing abilities of conventional software approaches to processing and submitting buy/sell orders.

Accordingly, a need exists in the art for processing and submitting buy/sell orders in a high speed and high throughput environment while complying with the specific requirements of particular trading venues.

### SUMMARY

The invention relates to a hardware-accelerated exchange order routing appliance. The invention combines hardware and software to facilitate a low latency and high throughput electronic order submission process to any trading venue, such as the New York Stock Exchange (“NYSE”), the National Association of Securities Dealers Automated Quotation System (“NASDAQ”), the Chicago Mercantile Exchange (“CME”), or other suitable “market exchange.” The appliance implements rules, protocols, and processes necessary to submit orders to and to receive execution reports and other related messages from any market exchange. The appliance also functions as a router, so a single appliance can be used for multiple market exchanges and for multiple customers. The appliance logs and stores all communicated messages and reports for future reference. The invention implements certain processing functions via a specialized hardware processor to remove that processing from the host operating system. The processing implementation can improve latency and throughput of order submission to the market exchanges.

According to one aspect of the invention, a client trading application communicates a trading order message to a client line handler of an order routing appliance. The client line handler communicates an acknowledgement receipt to the client trading application, communicates a copy of the message to a database update module of the order routing appliance for future reference, communicates a copy of the message to an order management system for tracking of the order, and communicates the message to a hardware processor of the order routing appliance. In the hardware processor of the order routing appliance, a message router receives the message, determines a particular market exchange to which the message is directed, and communicates the message to an exchange parser associated with the particular market exchange. The exchange parser transforms the message from an input protocol used by the client trading application to an order submission protocol specified by the particular market exchange and communicates the transformed message to an exchange line handler associated with the particular market exchange. The exchange line handler communicates the transformed message from the hardware processor to the particular market exchange for execution of trading order. The particular market exchange communicates an acknowledgement receipt report back to the exchange line handler in the hardware processor. The particular market exchange also executes the order specified in the trading order message and communicates an execution report to the exchange line handler. For each report received by the exchange line handler from the particular market exchange, the exchange line handler communicates the report to its associated exchange parser of the hardware processor. The exchange parser determines the client trading application to which the report is directed and transforms the report into the input protocol used by that client trading application. Then, the exchange parser communicates the transformed report to the message router of the hardware processor. The message router communicates the report to the client line handler associated with that client trading application, and the client line handler communicates the report to the client trading application.

These and other aspects, objects, and features of the invention will become apparent from the following detailed description of exemplary embodiments, read in conjunction with, and reference to, the accompanying drawings.

### BRIEF DESCRIPTION OF THE DRAWINGS

FIG. 1 is a block diagram depicting a system for processing securities trading order messages according to an exemplary embodiment.

FIG. 2 is a block diagram depicting the system of FIG. 1 for processing securities trading order messages and further depicting components of an order routing appliance within that system according to an exemplary embodiment.

FIG. 3 is a flow chart depicting a method for processing securities trading order messages according to an exemplary embodiment.

FIG. 4 is a flow chart depicting a method for receiving a trading order message according to an exemplary embodiment.

FIG. 5 is a flow chart depicting a method for determining a particular market exchange associated with a trading order message according to an exemplary embodiment.

FIG. 6 is a flow chart depicting a method for communicating a market exchange report to a particular client trading application according to an exemplary embodiment.

FIG. 7 is a block diagram depicting components of the order routing appliance according to an exemplary embodiment.

### DETAILED DESCRIPTION OF EXEMPLARY EMBODIMENTS

Referring to the drawings, in which like numerals represent like elements, aspects of the exemplary embodiments will be described.

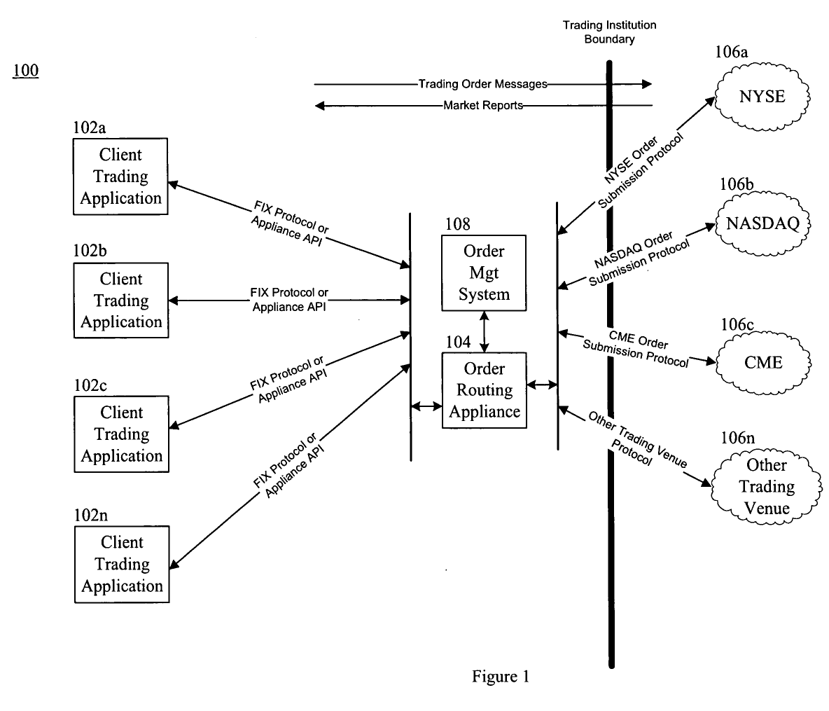

FIG. 1 is a block diagram depicting a system 100 for processing securities trading order messages according to an exemplary embodiment. As illustrated in FIG. 1, multiple client trading applications 102a-102n communicate trading order messages to an order routing appliance 104 of a broker or dealer for communication to one of multiple market exchanges 106a-106n for execution of the instructions in the trading order message. In response, the market exchanges 106a-106n communicate market reports to the order routing appliance 104 for communication to the client trading applications 102a-102n.

In exemplary embodiments, the trading order messages can comprise a buy order to purchase a security, a sell order to sell a security, an order status request regarding a previous buy or sell order, a cancel order to cancel a previous buy or sell order, or other suitable trading order message. In exemplary embodiments, the market reports can comprise an execution report regarding the completion of all or part of a buy or sell order, a status report regarding the status of a particular trading order message, or other suitable market report.

The client trading applications 102a-102n are software application programs operating on computer systems of the broker's or dealer's customers. The client trading applications 102a-102n generate and communicate the trading order messages or forward messages from another such system. The market exchanges 106a-106n can comprise the New York Stock Exchange (“NYSE”), the National Association of Securities Dealers Automated Quotation System (“NASDAQ”), the Chicago Mercantile Exchange (“CME”), or other suitable trading venue.

Each of the client trading applications 102a-102n communicates the messages to the order routing appliance 104 using a communication protocol specific to the particular application, and the communication protocol for one application may be different than or the same as the communication protocol for another application. For each message received by the order routing appliance 104 from one of the client trading applications 102a-102n, the order routing appliance 104 transforms the message from the communication protocol used by the respective client trading application 102a-102n into the communication protocol of the appropriate exchange 106a-106n to which the message is directed. For example, if the received message is directed to the NYSE, then the order routing appliance 104 transforms the message into the trading order message submission protocol specified by the NYSE. After transforming the message into the appropriate market exchange protocol, the order routing appliance 104 communicates the message to the appropriate market exchange 106a-106n.

In response to receiving the messages from the order routing appliance 104, the market exchanges 106a-106n execute the instructions in the messages and communicate reports back to the client trading applications 102a-102n via the order routing appliance 104. For each report received by the order routing appliance 104 from one of the market exchanges 106a-106n, the order routing appliance 104 transforms the report from the communication protocol used by the respective market exchange 106a-106n into the communication protocol of the client trading application 102a-102n to which the report is directed. For example, if the received report is directed to the client trading application 102a, then the order routing appliance 104 transforms the message into the communication protocol specified by the client trading application 102a. After transforming the message into the appropriate communication protocol, the order routing appliance 104 communicates the report to the appropriate market exchange 106a-106n.

Also as illustrated in FIG. 1, the order routing appliance 104 can communicate the trading order messages and the market reports to an order management system 108. The order management system is an electronic system that executes securities orders in an efficient and cost-effective manner. Brokers and dealers use order management systems when filling orders for various types of securities and are able to track the progress of each order throughout the system.

Thus, as illustrated in FIG. 1, trading order messages are communicated from multiple client trading applications 102a-102n to one or more market exchanges 106a-106n via the order routing appliance 104. In response, the market exchanges 106a-106n communicate market reports to the client trading applications 102a-102n via the order routing appliance 104. For each message, the order routing appliance 104 receives the message from one of the client trading applications 102a-102n, determines the particular market exchange 106a-106n to which to forward the message, transforms the message into the order submission protocol of the particular exchange 106a-106n, and communicates the message to the particular exchange 106a-106n. Additionally, for each report, the order routing appliance receives the report from one of the market exchanges 106a-106n, determines the particular client trading application 102a-102n to which to send the report, transforms the report into the particular communication protocol for the particular client trading application 102a-102n, and communicates the report to the particular client trading application 102a-102n.

In an exemplary embodiment, the client trading applications 102a-102n establish a connection to the order routing appliance 104 via the Financial Information eXchange (“FIX”) protocol. In an alternative exemplary embodiment, certain applications can connect to the order routing appliance 104 using a proprietary protocol that may offer lower latency than FIX. Currently, most U.S. equity market exchanges 106a-106n support FIX, but those exchanges typically use different versions of FIX. Accordingly, in an exemplary embodiment, the number of protocols implemented on the order routing appliance 104 may be limited to different versions of FIX.

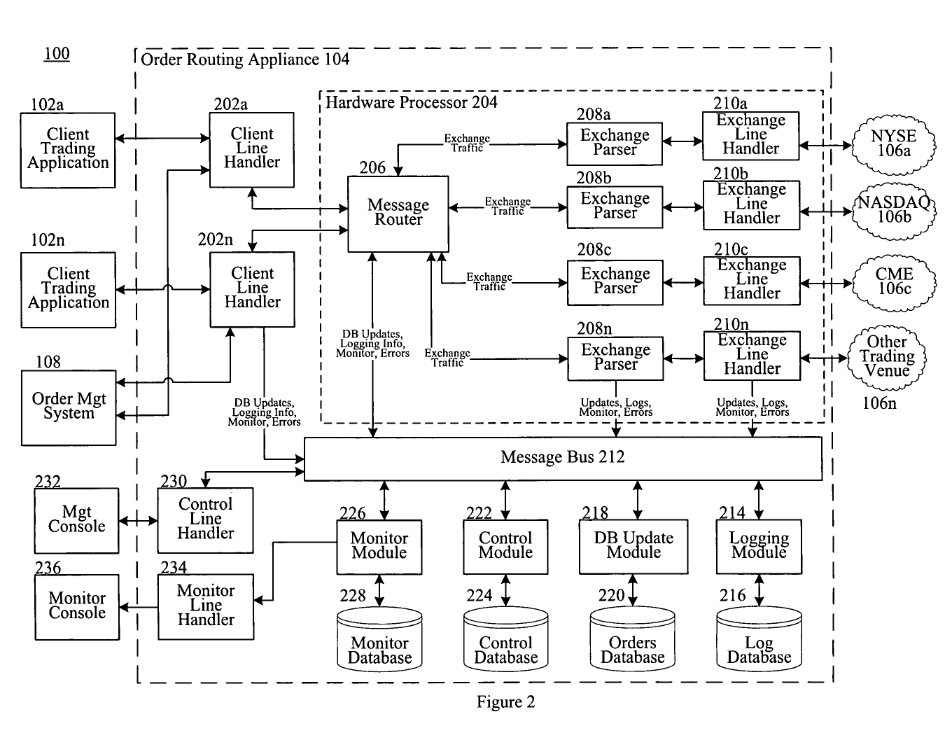

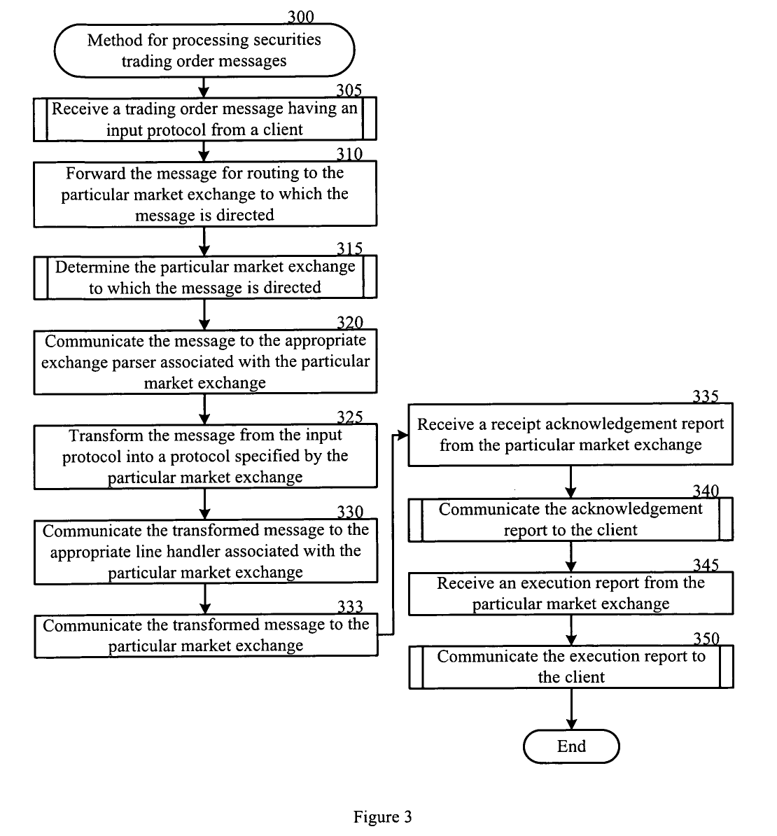

FIG. 2 is a block diagram depicting the system 100 for processing securities trading order messages as illustrated in FIG. 1 and further illustrating components of the order routing appliance 104 according to an exemplary embodiment. FIG. 2 will be described in further detail hereinafter with reference to FIGS. 3-6.

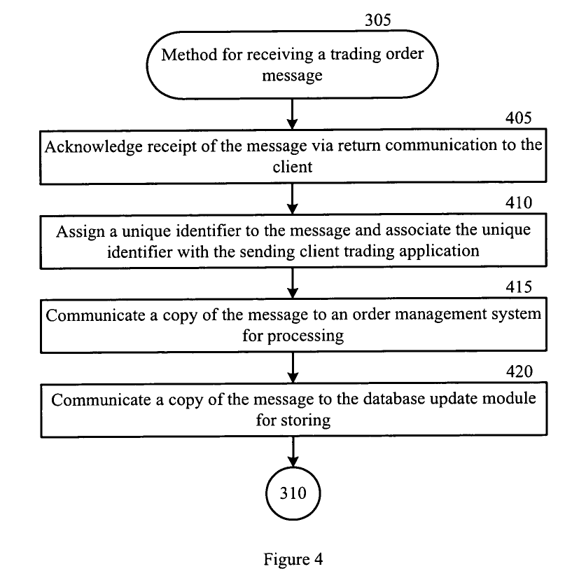

FIG. 3 is a flow chart depicting a method 300 for processing securities trading order messages according to an exemplary embodiment. Initially, a particular one of the client trading applications 102a-102n communicates a trading order message having an input protocol to the order routing appliance 104. More specifically, in step 305, a client line handler 202a-202n associated with the particular client trading application 102a-102n receives a trading order message having an input protocol from the corresponding client trading application 102a-102n. For example, if the client trading application 102a communicates the message to the order routing appliance 104, then the client line handler 202a corresponding to the client trading application 102a receives the message. The client line handlers 202a-202n are software modules that are responsible for session management and message exchange between the client trading applications 102a-102n and the order routing appliance 104. Step 305 will be described in further detail hereinafter with reference to FIG. 4.

In step 310, the client line handler 202a-202n that received the message forwards the message to a hardware processor 204 for routing of the message to a particular market exchange 106a-106n associated with the message. More specifically, in step 310, the client line handler 202a-202n that received the message forwards the message to a message router of the hardware processor 204 for routing of the message to a particular market exchange 106a-106n associated with the message. The message router 206 is a software module executing on the hardware processor 204 that is responsible for routing outbound (to the market exchanges 106a-106n) messages to the appropriate exchange line handler 210a-210n (described hereinafter) and routing inbound (from the market exchanges 106a-106n) reports to the appropriate client line handler 202a-202n.

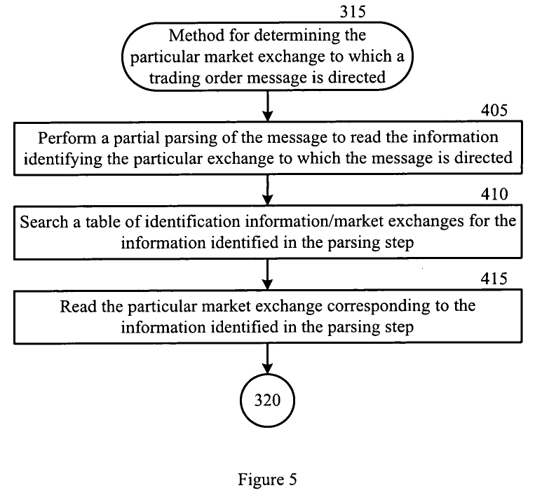

In step 315, the message router 206 determines the particular market exchange 106a-106n associated with the message. Step 315 will be described in further detail hereinafter with reference to FIG. 5.

In step 320, the message router 206 communicates the message to one of multiple exchange parsers 208a-208n associated with the particular market exchange 106a-106n. For example, if the message is directed to the NYSE 106a, then the message router 206 communicates the message to the appropriate exchange parser 208a associated with the NYSE 106a.

The exchange parsers 208a-208n are software modules executing on the hardware processor 204 that are responsible for protocol transformation. Accordingly, in step 325, the appropriate exchange parser 208a-208n transforms the message from the input protocol used by the client trading application 102a-102n into the order submission protocol specified by the particular market exchange 106a-106n. For example, if the message is directed to the NYSE 106a, then the exchange parser 208a transforms the message from the input protocol into the order submission protocol specified by the NYSE 106a.

Then, in step 330, the appropriate exchange parser 208a-208n communicates the transformed message to one of multiple exchange line handlers 210a-210n associated with the particular market exchange 106a-106n. The exchange line handlers 210a-210n are software modules executing on the hardware device 204 that are responsible for session management and message exchange between the order routing appliance 104 and the market exchanges 106a-106n. In step 333, the associated exchange line handler 210a-210n communicates the transformed message to the particular market exchange 106a-106n.

Upon receiving the message, the particular market exchange 106a-106n communicates an acknowledgement receipt report to the order routing appliance 104. More specifically, in step 335, the exchange line handler 210a-210n associated with the particular market exchange 106a-106n receives an acknowledgement report from the particular market exchange 106a-106n.

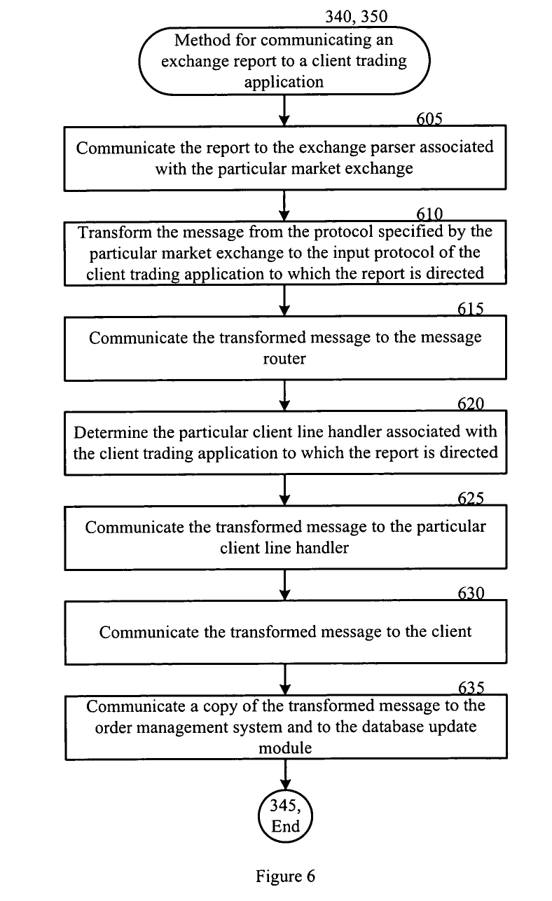

Then, in step 340, the order routing appliance 104 communicates the acknowledgment report to the client trading application 102a to which the acknowledgement report is directed. Step 340 will be described in further detail hereinafter with reference to FIG. 6.

Upon completing the trade as instructed in the trading order message from the client trading application 102a-102n, the particular market exchange 106a-106n communicates an execution report to the order routing appliance 104. More specifically, in step 345, the appropriate exchange line handler 210a-210n corresponding to the particular market exchange 106a-106n receives the execution report from the particular market exchange 106a-106n.

Then, in step 350, the order routing appliance 104 communicates the execution report to the appropriate client trading application 102a-102n to which the execution report is directed. Step 350 will be described in further detail hereinafter with reference to FIG. 6.

From step 350, the method 300 ends.

FIG. 4 is a flow chart depicting a method 305 for receiving a trading order message according to an exemplary embodiment, as referenced in step 305 of FIG. 3. FIG. 4 will be described with reference to FIGS. 2 and 3.

In step 405, the receiving client line handler 202a-202n acknowledges receipt of the message from the sending client trading application 102a-102n via a return communication from the receiving client line handler 202a-202n to the sending client trading application 102a-102n.

In step 410, the receiving client line handler 202a-202n assigns and stores a unique identifier to the message received from the client trading application 102a-102n. The identifier is associated with the sending client trading application 102a-102n in a table stored in the order routing appliance 104. Subsequent communications between the sending client trading application 102a-102n, the order routing appliance 104, and a particular market exchange 106a-106n can reference the unique identifier. Accordingly, all messages, including the unique identifier, can be associated with each other for future reference and to identify the appropriate party to receive such messages.

In step 415, the receiving client line handler 202a-202n communicates a copy of the message from the sending client trading application 102a-102n to the order management system 108 for order management processing. Additionally, in step 420, the receiving client line handler 202a-202n communicates a copy of the message received from the sending client trading application 102a-102n to a database update module 218 via a message bus 212 for storing in an orders database 220. The database update module 218 is a software module that is responsible for persisting all order information into the orders database 220. Accordingly, the database update module 218 stores a copy of each message received by the order routing appliance 104. Such storing can allow future review of any message received by the order routing appliance 104.

From step 420, the method 305 proceeds to step 310 (FIG. 3).

FIG. 5 is a flow chart depicting a method 315 for determining the particular market exchange 106a-106n associated with a trading order message according to an exemplary embodiment, as referenced in step 315 of FIG. 3. FIG. 5 will be described with reference to FIGS. 2 and 3.

In step 405, the message router 206 performs partial parsing of the message to read information in the message that identifies the particular market exchange 106a-106n to which the message is directed. Then, in step 410, the message router 206 searches a stored table of identification information and corresponding market exchanges for the information identified in the parsing step. In step 415, the message router 206 reads the particular market exchange 106a-106n corresponding to the information identified in the parsing step.

From step 415, the method 315 proceeds to step 320 (FIG. 3).

FIG. 6 is a flow chart depicting a method 340, 350 for communicating a market exchange report to a particular client trading application 102a-102n according to an exemplary embodiment, as referenced in step 340 or 350 of FIG. 3. The method depicted in FIG. 6 can be used to communicate any market exchange report from one of the market exchanges 106a-106n to a particular client trading application 102a-102n to which the report is directed. FIG. 6 will be described with reference to FIGS. 2 and 3.

As stated in steps 335 and 345 of FIG. 3, one of the exchange line handlers 210a-210n receives an exchange report from a corresponding market exchange 106a-106n. For example, if the NYSE 106a communicates the report, then the exchange line handler 210a receives the report. Accordingly, in step 605 of FIG. 6, the receiving exchange line handler 210a-210n communicates the report to the appropriate exchange parser 208a-208n associated with the receiving exchange line handler 210a-210n. For example, if the exchange line handler 210a receives the report, then the exchange line handler 210a communicates the report to the associated exchange parser 208a.

In step 610, the receiving exchange parser 208a-208n transforms the exchange report from the protocol specific to the particular market exchange 106a-106n to the input protocol of the particular client trading application 102a-102n to which the report is directed. In an exemplary embodiment, the receiving exchange parser 208a-208n can determine the identity of the client trading application 102a-102n based on the unique identifier or other information in the report. Based on the identifying information from the report, the receiving exchange parser 208a-208n can determine the appropriate protocol from a table and can subsequently convert the report into the appropriate protocol.

In step 615, the receiving exchange parser 208a-208n communicates the transformed message to the message router 206.

In step 620, the message router 206 determines the particular client trading application 102a-102n to which the message is directed. In an exemplary embodiment, the message router 206 can make that determination by performing a partial parsing of the message to read information identifying the particular client trading application 102a-102n to which the message is directed. In an exemplary embodiment, the identifying information can comprise the unique identifier previously assigned to related messages. Then, the message router 206 can search a table of identification information/client trading applications 102a-102n for the information identified in the parsing step. Finally, the message router 206 can read the particular client trading application 102a-102n corresponding to the information identified in the parsing step.

In step 625, the message router 206 communicates the transformed message to the appropriate client line handler associated with the particular client trading application 102a-102n. For example, if the particular client trading application is the client trading application 102a, then the message router 206 communicates the transformed message to the corresponding client line handler 202a. Then, in step 630, the client line handler 202a-202n communicates the transformed message to the particular client trading application 102a-102n.

Additionally, in step 635, the client line handler 202a-202n also communicates a copy of the transformed message to the order management system 108 for order management processing and to the database update module 218 for storing in the orders database 216.

From step 635, the method 340 proceeds to step 345 (FIG. 3), and the method 350 proceeds to the end of the method 300 (FIG. 3).

The order routing appliance 104 can process multiple trading order messages and exchange reports simultaneously and can perform the processing described herein with regard to each message and report. In an exemplary embodiment, the order routing appliance can buffer or queue messages and reports as they are received and can process each item in the order it is received. Additionally or alternatively, the order routing appliance can be multi-threaded to process multiple messages and/or reports at the same time.

In another exemplary embodiment, the order routing appliance 104 can comprise multiple hardware processors 204.

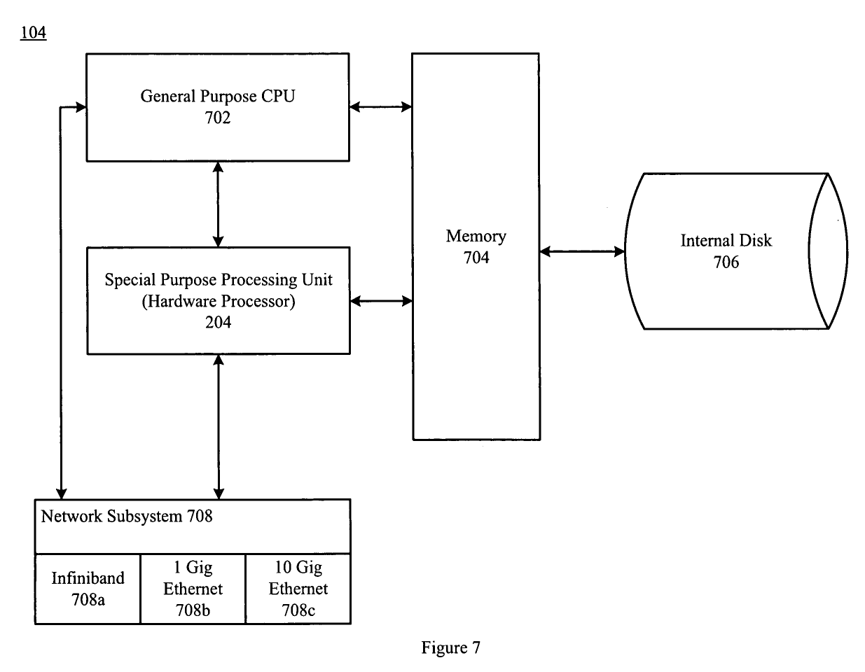

FIG. 7 is a block diagram depicting components of the order routing appliance 104 according to an exemplary embodiment. FIG. 7 will be described with reference to FIG. 7. As illustrated in FIG. 7, the order routing appliance 104 comprises a general purpose computer processing unit (“CPU”) 702 and a special purpose processing unit 204. The general purpose CPU 702 comprises the following components illustrated in FIG. 2: the client line handlers 202a-202n, the message bus 212, a logging module 214, the database update module 218, a control module 222, a monitor module 226, a control line handler 230, and a monitor line handler 234.

The control module 222 is a software module that is responsible for effecting control directives received from the control line handler 230 and for recording control directives and changes into a control database 224. The control line handler 230 is a software module that is responsible for session management and message exchange between the control module 222 and a management console 232. Support personnel operating the management console 232 may use this connection to control operation of the order routing appliance 104.

The logging module 214 is a software module that is responsible for persisting all log messages into a log database 216 and logs all events occurring in the order routing appliance 104.

The message bus 212 is the order routing appliance's internal publish/subscribe mechanism.

The monitor module 226 is a software module that is responsible for aggregating and forwarding monitoring information to the monitor line handler 234 for subsequent distribution to monitor clients, such as a monitor console 236. Accordingly, the monitor module 226 monitors the operations of the order routing appliance 104, stores monitoring information in a monitor database 228, and communicates the monitoring information to the monitor console 236 via the monitor line handler 234. The monitor line handler 234 is a software module that is responsible for session management and message routing of monitor traffic to the monitor console 236. The monitoring information can comprise performance information of the running appliance 104, such as a number of messages and reports sent/received, connections up/down state, errors, or any other suitable performance information and can be used by operations staff for proactive management of the system 100. In an exemplary embodiment, the components of the general purpose CPU can be implemented in a server configuration.

The special purpose processing unit 204 is the hardware processor 204 depicted in FIG. 2 and comprises the following components illustrated in FIG. 2: the message router 206, the exchange parsers 208a-208n, and the exchange line handlers 210a-210n. The hardware processor 204 comprises a specialized hardware component that accelerates certain processing functions for incoming and outgoing messages and reports. Specifically, the hardware processor 204 accelerates the processing functions performed by the message router 204, the exchange parsers 208a-208n, and the exchange line handlers 210a-210n.

In an exemplary embodiment, the order routing appliance 104 can be implemented using a Nexten hardware card operating as the hardware processor 204 combined with an BP BladeSystem c-Class Server combination comprising the remaining components of the order routing appliance 104. In an alternative exemplary embodiment, the hardware processor 204 can comprise a field programmable gate array (“FPGA”) or other suitable hardware accelerator.

The order routing appliance 104 depicted in FIG. 7 further comprises a memory 704, in internal disk 706, and a network subsystem 708. The memory 704 comprises the following components illustrated in FIG. 2: the log database 216, the orders database 220, the control database 224, and the monitor database 228. The internal disk 706 provides memory for storing operational information, such as incoming and outgoing messages, configuration details, or other suitable operational details. The network subsystem 708 comprises networking components, such as an Infiniband 708a, a 1-Gig Ethernet 708b, and a 10-Gig Ethernet 708c.

In an alternative exemplary embodiment of the system 100, the client trading applications 102a-102n can communicate messages to the order management system 108, which then communicates the messages to the order routing appliance 104, without changing the scope of the invention described herein. In this embodiment, reports from the market exchanges 106a-106n are communicated from the order routing appliance 104 to the order management system 108 to the client trading applications 102a-102n.

In an exemplary embodiment, the order routing appliance can be implemented in conjunction with additional components not illustrated in FIGS. 1, 2, or 7. For example, a smart order router can be included to execute various trading strategies to obtain the best execution price. For example, the smart order router can take an order for 5000 shares and, instead of sending the order to a single exchange, the smart order router will break the order into multiple smaller orders and send the smaller orders to different exchanges. The goal is to achieve a better average execution price compared to sending the order to a single exchange. A compliance module also can be included to ensure compliance with securities regulations.

Although not illustrated in FIGS. 1 and 2, the client trading applications 102a-102n, the order management system 108, the market exchanges 106a-106n, the management console 232, and the monitor console 236 can communicate with the order routing appliance via any suitable network, such as the Internet, an intranet, leased lines, or other suitable communication medium.

The present invention comprises a computer program that embodies the functions described herein and illustrated in the appended flow charts. However, it should be apparent that there could be many different ways of implementing the invention in computer programming, and the invention should not be construed as limited to any one set of computer program instructions. Further, a programmer would be able to write such a computer program to implement an embodiment of the disclosed invention based on the block diagrams, flow charts, and associated description in the application text. Therefore, disclosure of a particular set of program code instructions is not considered necessary for an adequate understanding of how to make and use the invention. The inventive functionality of the claimed computer program has been explained in detail in the previous description read in conjunction with the Figures illustrating the program flow.

Although specific embodiments of the present invention have been described herein in detail, the description is merely for purposes of illustration. The exemplary systems and methods described herein are merely illustrative and, in alternative embodiments of the invention, certain steps can be performed in a different order, performed in parallel with one another, or omitted entirely, certain additional steps can be performed without departing from the scope and spirit of the invention, and/or certain components can be added to, removed from, or relocated within the system without departing from the scope and spirit of the invention. Additionally, various modifications of, and equivalent steps or features corresponding to, the disclosed aspects of the exemplary embodiments, in addition to those described herein, can be made by those having ordinary skill in the art without departing from the spirit and scope of the present invention defined in the following claims, the scope of which is to be accorded the broadest interpretation so as to encompass such modifications and equivalent structures.

What is claimed is:

1. A system for processing trading order messages for execution by market exchanges, comprising:
a general purpose processor that receives a trading order message; and
a special purpose processor logically linked to the general purpose processor, the special purpose processor being configured to receive the message from the general purpose processor, to determine a particular market exchange to which the message is directed, and to communicate the message in a protocol specified by the particular market exchange.

2. The system of claim 1, wherein the special purpose processor comprises:
a message router module that determines the particular market exchange to which the message is directed; and
a parsing module that transforms the message into the protocol specified by the particular market exchange.

3. The system of claim 2, wherein the special purpose processor further comprises an exchange line handler module that communicates the transformed message.

4. The system of claim 1, wherein the special purpose processor comprises:
a plurality of parsing modules, each of the parsing modules being associated with one of a plurality of market exchanges, the particular market exchange being one of the plurality of market exchanges; and
a message router module that determines the particular market exchange to which the message is directed and that communicates the message to a particular one of the parsing modules that is associated with the particular market exchange,
wherein the particular one of the parsing modules transforms the message into the protocol specified by the particular market exchange.

5. The system of claim 1, wherein the special purpose processor comprises:
a parsing module that transforms the message into the protocol specified by the particular market exchange;
a message router that determines the particular market exchange to which the message is directed and that communicates the message to the parsing module; and
a plurality of exchange line handler modules, each of the exchange line handler modules being associated with one of a plurality of market exchanges, the particular market exchange being one of the plurality of market exchanges,
wherein the parsing module communicates the transformed message to a particular one of the exchange line handler modules that is associated with the particular market exchange.

6. The system of claim 1, further comprising an order management system that manages the execution of trading order messages received by or destined to the general purpose processor.

7. The system of claim 1, wherein the general purpose processor comprises a server, and wherein the special purpose processor comprises a hardware device linked to the server.

8. The system of claim 1, wherein the general purpose processor receives the trading order message from a client trading application.

9. A system for processing trading order messages for execution by market exchanges, comprising:
a general purpose processor that receives a trading order message destined for a particular market exchange; and
a special purpose processor logically linked to the general purpose processor, the special purpose processor comprising
a plurality of exchange line handler modules, each of the exchange line handler modules being associated with one of a plurality of market exchanges, the particular market exchange being one of the plurality of market exchanges,
a plurality of parsing modules, each of the parsing modules being associated with one of the exchange line handler modules, and
a message router module that receives the message from the general purpose processor and communicates the message to a particular one of the parsing modules that is associated with a particular one of the exchange line handlers that is associated with the particular market exchange,
wherein the particular one of the parsing modules transforms the message into a protocol specified by the particular market exchange and communicates the transformed message to the particular one of the exchange line handlers for communication to the particular market exchange.

10. The system of claim 9, further comprising an order management system that manages the execution of trading order messages received by or destined to the general purpose processor,
wherein the general purpose processor communicates the message to the order management system.

11. The system of claim 9, wherein the general purpose processor comprises a server, and wherein the special purpose processor comprises a hardware device linked to the server.

12. The system of claim 9, wherein the general purpose processor receives the trading order message from a client trading application.

13. A method for processing trading order messages for execution by market exchanges, the trading order messages being received by a general purpose processor and being transformed and communicated by a hardware device logically linked to the general purpose processor, comprising the steps of:
within the hardware device, receiving a trading order message from the general purpose processor, determining a particular market exchange to which the message is directed, and communicating the message in a protocol for submission to the particular market exchange.

14. The method of claim 13, wherein the step of determining the particular market exchange to which the message is directed is performed by a message router of the hardware device, and
wherein the step of transforming the message into the protocol for submission to the particular market exchange is performed by a parsing module of the hardware device.

15. The method of claim 14, wherein the step of communicating the message in a protocol for submission to the particular market exchange comprises communicating the transformed message via an exchange line handler module of the hardware device.

16. A method for processing trading order messages for execution by market exchanges, the trading order messages being received by a general purpose processor and being transformed and communicated by a hardware device logically linked to the general purpose processor, comprising the steps of:
on a message router module of the hardware device, receiving a trading order message from the general purpose processor, determining a particular market exchange to which the message is directed, and communicating the message to a particular one of a plurality of parsing modules of the hardware device that is associated with a particular one of a plurality of exchange line handlers that is associated with the particular market exchange,
on the particular one of the parsing modules, transforming the message into a protocol specified by the particular market exchange and communicating the transformed message to the particular one of the exchange line handlers; and
on the particular one of the exchange line handlers, communicating the transformed message for receipt by the particular market exchange.

17. The method of claim 16, further comprising the step of managing the execution of the message.
